(19) United States
(12) Patent Application Publication
(10) Pub. No.: US 2012/0058298 A1
(43) Pub. Date: Mar. 8, 2012

(54) COVER SHEET ANCHOR

(76) Inventor: Milan Popovic, Edmonton (CA)

(21) Appl. No.: 12/877,915

(22) Filed: Sep. 8, 2010

(51) Int. Cl. B32B 3/06

(52) U.S. Cl. 428/99

(57) ABSTRACT

A cover sheet anchor including a strip of material that is detachably secured to a cover sheet. At least one anchoring layer with a sticky backing is attached to the strip of material, whereby the cover sheet is temporarily anchored to a floor by the anchoring layer.

### FIELD

There is described a cover sheet anchor that is used to anchor a cover sheet which is used to prevent dust or paint splatter from contaminating walls and floors.

### BACKGROUND

Painters use a cover sheet to prevent paint splatters on wall and floor areas. Unfortunately, movement of people, supplies or equipment across the cover sheet, frequently results in the cover sheet being shifted out of position, thereby leaving portions of the floor exposed.

### SUMMARY

There is provided a cover sheet anchor including a strip of material that is detachably secured to a cover sheet. At least one anchoring layer with a sticky backing is attached to the strip of material, whereby the cover sheet is temporarily anchored to a floor by the anchoring layer.

As will hereinafter be further described, the cover sheet anchor described uses a sticky backing that uses an adhesive developed by 3M Corporation that will not harm the floor or leave an adhesive residue. The sticky backing works in a manner that is analogous to Post It Notes (trademark), except that the adhesive is more powerful. Through experimentation, it has been determined that this type of cover sheet anchor is effective on a wide variety of types of flooring including wood floors, tile, linoleum, and carpet.

Through use over time, the sticky backing will inevitably become contaminated or ineffective. Even more beneficial results may, therefore, be obtained when there are several anchoring layers. When the sticky backing of one anchoring layer becomes contaminated or ineffective, it is removed to expose another of the several anchoring layers.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a top plan view of a cover sheet anchor constructed in accordance with the teachings of the present invention.

FIG. 2 is a bottom plan view of the cover sheet anchor illustrated in FIG. 1.

FIG. 3 is a perspective view of the cover sheet anchor illustrated in FIG. 1 in use anchoring a cover sheet to a floor.

### DETAILED DESCRIPTION

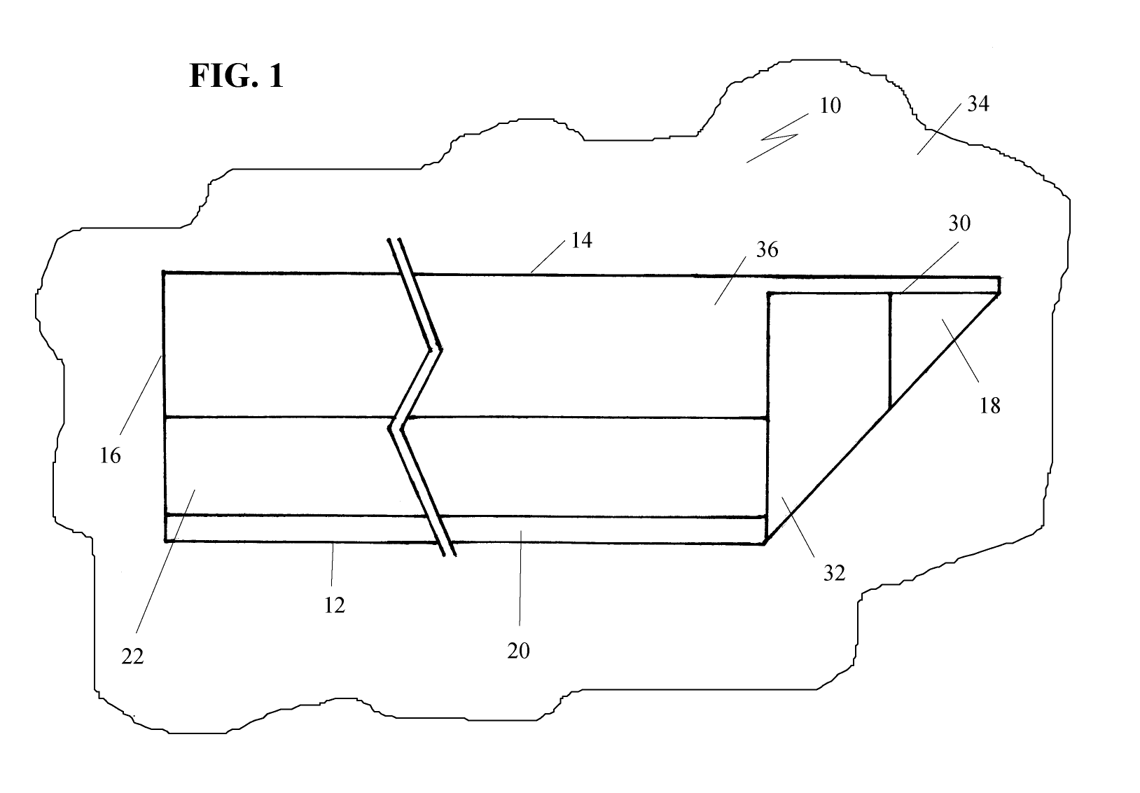

A cover sheet anchor generally identified by reference numeral 10, will now be described with reference to FIG. 1 through 3.

### Structure and Relationship of Parts:

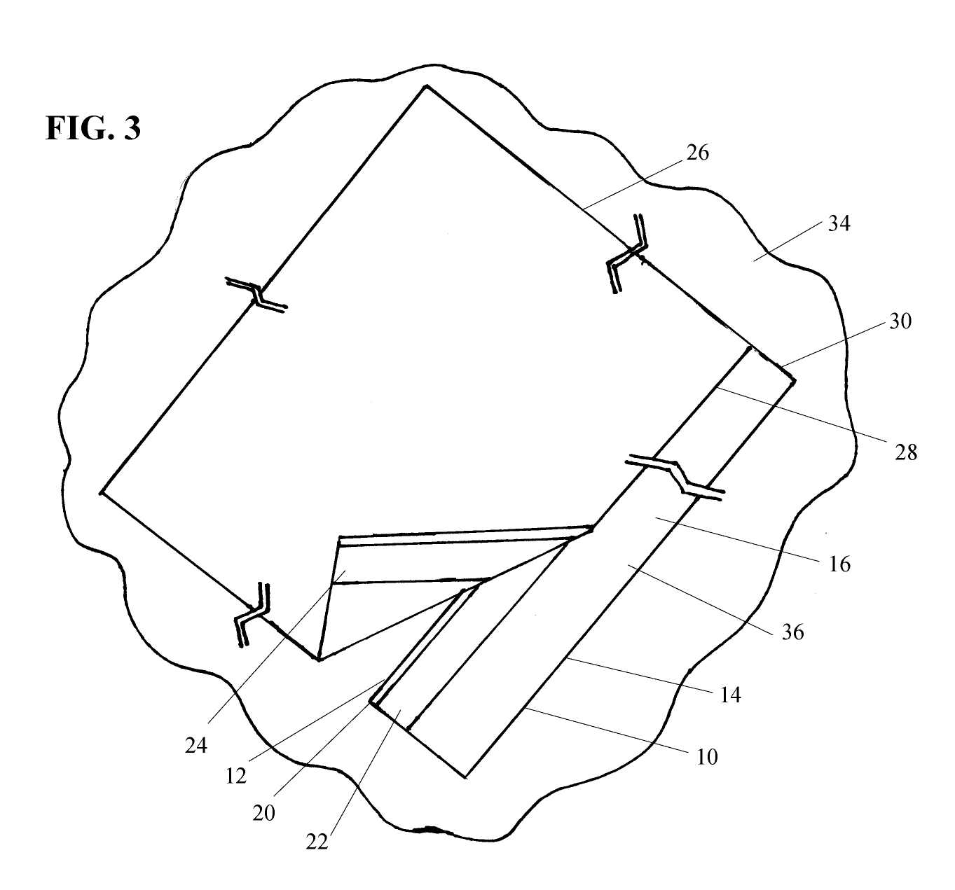

Referring to FIG. 1, cover sheet anchor 10 has a first edge 12, a second edge 14, a front side 16, and a back side 18. Cover sheet anchor 10 is comprised of strip of material 20. A tape fastener 22 is attached to strip of material 20 along first edge 12 on front side 16. Referring to FIG. 3, tape fastener 22 mates with mating tape fastener 24 carried by cover sheet 26 for detachably securing strip of material 20 along first edge 28 of cover sheet 26.

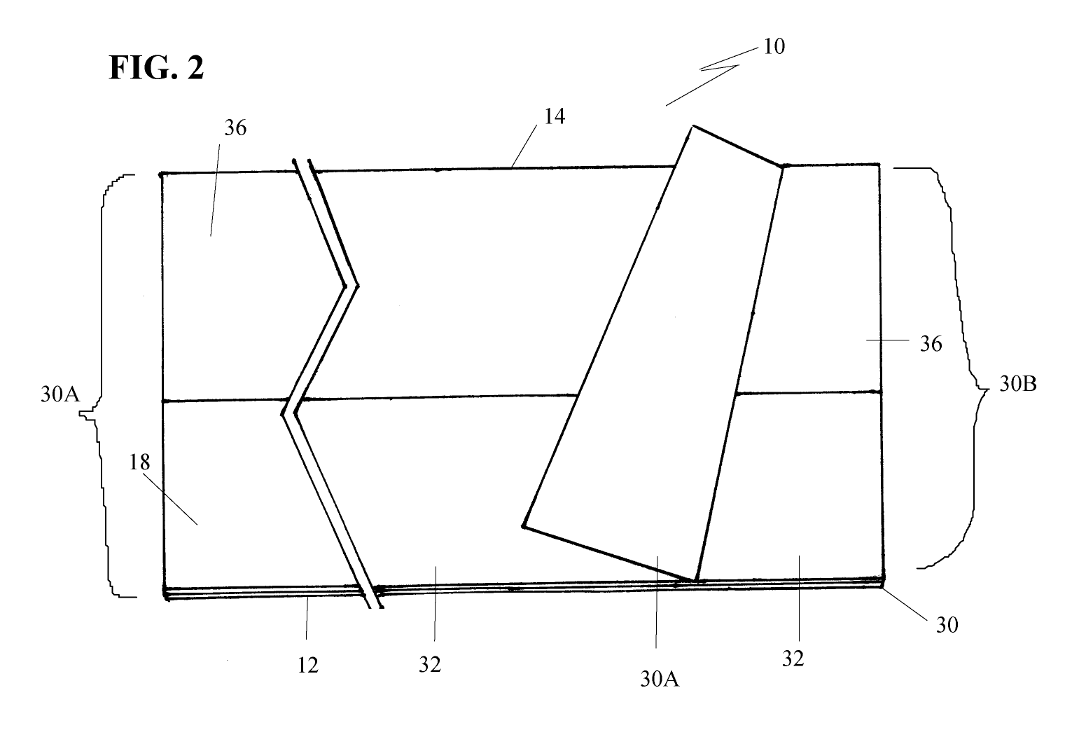

Referring to FIG. 2, attached on the back side 18 of strip of material 20 of cover sheet anchor 10 are several anchoring layers 30. Anchoring layers 30 consist of a sticky backing 32 along first edge 12 and, preferably include a non-sticking extension 36 which extends past second edge 14. Referring to FIG. 3, anchoring layers 30 are used to temporarily anchor cover sheet 26 to floor 34 by means of sticky backing 32. Referring to

FIG. 2, when the sticky backing 32 of the exposed one 30A of the anchoring layers 30 becomes contaminated or ineffective, it is removed. When the exposed anchoring layer 30A is removed it exposes another 30B of the several anchoring layers 30. As previously indicated, it is preferred that each of the several anchoring layers 30 have a non-sticking extension 36 that extends past second edge 14 of cover sheet anchor 10. It is, preferably in the form of a polymer plastic cover strip which runs along the length of the strip of material 20. Non-sticking extension 36 provides a means to grasp each anchoring layer 30 for removal It also serves to shield the sticky backing 32 from contaminants. It will be apparent to one skilled in the art that non-sticking extension 36 is desirable but not essential.

### Operation:

The use and operation of the cover sheet anchor 10 will now be described with reference to FIG. 1 through 3. Referring to FIG. 3, the tape fastener 22 on cover sheet anchor 10 mates with the mating tape fastener 24 to secure the first edge 12 of the cover sheet anchor 10 along the first edge 28 of the cover sheet 26. The mated cover sheet anchor 10 and cover sheet 26 are then positioned on the floor 34. Referring to FIG. 1, cover sheet anchor 10 is then attached to the floor 34 by the sticky backing 32. Referring to FIG. 3, the non-sticking extension 36 faces in the opposite direction from the cover sheet 26. Non-sticking extension 36 extends past second edge of material 20 and first edge 28 of the cover sheet 26 to shield sticky backing 32 from contaminants. Sticky backing 32 is not seen in this view but can be viewed in FIG. 1 and FIG. 2.

Upon completion of the use of the cover sheet 26, the mated cover sheet anchor 10 and cover sheet 26 are removed from the floor 34 by disengaging the sticky backing 32 of the anchoring layers 30 from the floor 34. It will be apparent to one skilled in the art that the cover sheet anchor is not limited to use on floors, but may be used to cover other surfaces, such as walls.

Referring to FIG. 2, upon the sticky backing 32 becoming contaminated or ineffective, anchoring layer 30A can be peeled off the back side 18 of the cover sheet anchor 10 and be disposed of Anchoring layer 30B can then be used to temporarily anchor the cover sheet anchor 10 to the floor 34.

### Example

There will now be described an example of a cover sheet anchor which has been made commercially in accordance with the above teachings, including dimensions, the number of layers and the particular adhesive used:

The cover sheet anchor which has been made commercially in accordance with the above teachings is 76.2 mm by 1117.6 mm and consists of ten anchoring layers with polyethylene tape sold by 3M as 3M 4179C being the source for the sticky backing. Until needed, a throwaway cover covers the exposed layer of the polyethylene tape to prevent contamination or unwanted sticking during transit. Material 20 is a foam pad layer which serves as backing for the tape fasteners and polyethylene tape.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A cover sheet anchor, comprising:
a strip of material;
means for detachably securing the strip of material to a cover sheet;
at least one anchoring layer with a sticky backing attached to the strip of material whereby the cover sheet is temporarily anchored to a floor by the at least one anchoring layer.

2. The cover sheet anchor of claim 1, wherein the means for detachably securing the strip of material to a cover sheet are a tape fastener on the strip of material which mates with a mating tape fastener carried by the cover sheet.

3. The cover sheet anchor of claim 1, wherein there are several anchoring layers, such that when the sticky backing of one anchoring layer becomes contaminated or ineffective, it is removed to expose another of the several anchoring layers.

4. The cover sheet anchor of claim 3, wherein each anchoring layer has a non-sticking extension wherein each anchoring layer is grasped for removal.

5. The cover sheet anchor of claim 4, wherein the non-sticking extension is a polymer plastic cover strip which runs a length of the strip of material.

6. A cover sheet anchor, comprising:
a strip of material;
means for detachably securing the strip of material to a cover sheet;
several anchoring layers with a sticky backing on each of the several anchoring layers, the anchoring layer being attached to the strip of material whereby the cover sheet is temporarily anchored to a floor by an exposed one of the several anchoring layers, when the sticky backing of the exposed one of the anchoring layers becomes contaminated or ineffective, it is removed to expose another of the several anchoring layers, each of the several anchoring layers having a non-sticking extension wherein each anchoring layer is grasped for removal.

7. The cover sheet anchor of claim 6, wherein the means for detachably securing the strip of material to a cover sheet are a tape fastener on the strip of material which mates with a mating tape fastener carried by the cover sheet.

8. The cover sheet anchor of claim 6, wherein the non-sticking extension is a polymer plastic cover strip which runs a length of the strip of material.

9. A cover sheet anchor, comprising:
a strip of material;
a tape fastener on the strip of material which mates with a mating tape fastener carried by a cover sheet for detachably securing the strip of material along a peripheral edge of a cover sheet;
several anchoring layers with a sticky backing on each of the several anchoring layers, the several anchoring layers being attached to the strip of material whereby the cover sheet is temporarily anchored to a floor by an exposed one of the several anchoring layers, when the sticky backing of the exposed one of the anchoring layers becomes contaminated or ineffective, it is removed to expose another of the several anchoring layers, each of the several anchoring layers having a non-sticking extension wherein each anchoring layer is grasped for removal, the non-sticking extension being a polymer plastic cover strip which runs a length of the strip of material and serves to shield the sticky backing from contaminants.
